(19) United States
(12) Patent Application Publication
(10) Pub. No.: US 2026/0217316 A1
(43) Pub. Date: Jul. 30, 2026

(54) VEHICLE LOWER PORTION STRUCTURE

(71) Applicant: TOYOTA JIDOSHA KABUSHIKI KAISHA, Aichi-ken (JP)

(72) Inventors: Hisashi MISAWA, Toyota-shi (JP); Ryosuke CHIKAZAWA, Toyota-shi (JP)

(21) Appl. No.: 19/414,268

(22) Filed: Dec. 10, 2025

(30) Foreign Application Priority Data
Jan. 24, 2025 (JP) 2025-010458

(51) Int. Cl. B62D 21/02; B60K 1/04; H01M 50/242; H01M 50/249

(52) U.S. Cl. CPC B62D 21/02; B60K 1/04; H01M 50/242; H01M 50/249; H01M 2220/20

(57) ABSTRACT

A vehicle lower portion structure includes a left and right pair of side frames, a battery pack, a cross member, and an energy absorption member. In a bottom view, a vehicle width direction outer side end portion of the cross member is bent toward a vehicle front-rear direction outer side, starting from a portion at which the vehicle width direction outer side end portion reaches the energy absorption member, and is attached to one of the side frames, and a vehicle front-rear direction outer side end portion of the energy absorption member is disposed along a face, of the vehicle width direction outer side end portion of the cross member, that faces toward a vehicle front-rear direction inner side. A reinforcing member is provided at a portion at which the cross member is bent.

### CROSS-REFERENCE TO RELATED APPLICATION

This application is based on and claims priority under 35 USC 119 from Japanese Patent Application No. 2025-010458 filed on Jan. 24, 2025, the disclosure of which is incorporated by reference herein in its entirety.

### BACKGROUND

### Technical Field

The present disclosure relates to a vehicle lower portion structure.

### Related Art

A vehicle body structure of an electric vehicle in which plural cross members extending in a vehicle width direction are installed so as to span between a left and right pair of frames extending in a front-rear direction, and in which a battery pack is disposed at an upper side of the plural cross members, is conventionally known (refer to, for example, Japanese Patent Application Laid-Open (JP-A) No. 2018-144700).

Incidentally, in a frame vehicle, in order to suppress twisting thereof, a cross member is installed so as to span between a left and right pair of side frames. However, in a case in which an energy absorption member is disposed at a vehicle width direction outer side of the battery pack and at a vehicle lower side of the side frame, in order to accommodate a vehicle width direction outer side end portion of the cross member, it is necessary to cut out a portion of the energy absorption member in a substantially rectangular shape in bottom view.

Thus, at the time of a side collision of the vehicle or the like, if a load is input to the energy absorption member from a vehicle width direction outer side, a tensile stress that is relatively directed toward the vehicle width direction outer side by the vehicle width direction outer side end portion of the cross member is exerted on the portion of the energy absorption member that accommodates the vehicle width direction outer side end portion of the cross member, and there is a risk that the energy absorption member may be broken. That is to say, there is a possibility that impact absorption performance with respect to a load that is input from the vehicle width direction outer side may not be sufficiently exhibited.

### SUMMARY

The present disclosure provides a vehicle lower portion structure that is capable of suppressing a reduction in impact absorption performance with respect to a load that is input from a vehicle width direction outer side.

A vehicle lower portion structure of a first aspect according to the present disclosure includes: a left and right pair of side frames that extend in a vehicle front-rear direction; a battery pack that is disposed between the side frames; a cross member that is installed so as to span between the side frames at a vehicle lower side of the battery pack; and an energy absorption member that is disposed at a vehicle width direction outer side of the battery pack and at a vehicle lower side of each side frame, wherein, in a bottom view, a vehicle width direction outer side end portion of the cross member is bent toward a vehicle front-rear direction outer side, starting from a portion at which the vehicle width direction outer side end portion reaches the energy absorption member, and is attached to one of the side frames, a vehicle front-rear direction outer side end portion of the energy absorption member is disposed along a face, of the vehicle width direction outer side end portion of the cross member, that faces toward a vehicle front-rear direction inner side, and a reinforcing member including a flat face that faces the energy absorption member in a vehicle width direction is provided at a portion at which the cross member is bent.

According to the vehicle lower portion structure of the first aspect, the battery pack is disposed between the left and right pair of side frames that extend in the vehicle front-rear direction. Further, the cross member is installed so as to span between the side frames at the vehicle lower side of the battery pack, and the energy absorption member is disposed at the vehicle width direction outer side of the battery pack and at the vehicle lower side of each side frame.

In this regard, in a bottom view, the vehicle width direction outer side end portion of the cross member is bent toward the vehicle front-rear direction outer side, starting from the portion at which the vehicle width direction outer side end portion reaches the energy absorption member, and is attached to one of the side frames, and the vehicle front-rear direction outer side end portion of the energy absorption member is disposed along the face, of the vehicle width direction outer side end portion of the cross member, that faces toward the vehicle front-rear direction inner side. Further, the reinforcing member including the flat face that faces the energy absorption member in the vehicle width direction is provided at the portion at which the cross member is bent.

Accordingly, during a side collision or the like of the vehicle, even if a load is input to the energy absorption member from the vehicle width direction outer side, a tensile stress that is relatively directed toward the vehicle width direction outer side by the vehicle width direction outer side end portion of the cross member is unlikely to be exerted on the vehicle front-rear direction outer side end portion of the energy absorption member, and the energy absorption member is unlikely to be broken. Consequently, a load that has been input from the vehicle width direction outer side is effectively absorbed by the energy absorption member, and is effectively received by the reinforcing member. That is to say, a reduction in impact absorption performance with respect to a load that is input from the vehicle width direction outer side is suppressed.

Further, a vehicle lower portion structure of a second aspect according to the present disclosure includes: a vehicle body frame including a left and right pair of side frames that extend in a vehicle front-rear direction, a front portion frame that couples vehicle front side portions of the side frames in a vehicle width direction, and a rear portion frame that couples vehicle rear side portions of the side frames in the vehicle width direction; a battery pack that is disposed at an inner side of the vehicle body frame; a sub frame that includes a cross member installed so as to span between the side frames at a vehicle lower side of the battery pack, and that supports the battery pack from the vehicle lower side; and an energy absorption member that is disposed at a vehicle width direction outer side of the battery pack and at a vehicle lower side of each side frame, wherein, in a bottom view, a vehicle width direction outer side end portion of the cross member is bent toward a vehicle front-rear direction outer side, starting from a portion at which the vehicle width direction outer side end portion reaches the energy absorption member, and is attached to one of the side frames, a vehicle front-rear direction outer side end portion of the energy absorption member is disposed along a face, of the vehicle width direction outer side end portion of the cross member, that faces toward a vehicle front-rear direction inner side, and a reinforcing member including a flat face that faces the energy absorption member in the vehicle width direction is provided at a portion at which the cross member is bent.

According to the vehicle lower portion structure of the second aspect, the vehicle body frame is configured due to the vehicle front side portions of the left and right pair of side frames that extend in the vehicle front-rear direction being coupled in the vehicle width direction by the front portion frame, and due to the vehicle rear side portions of the side frames being coupled in the vehicle width direction by the rear portion frame. Further, the battery pack is disposed at the inner side of the vehicle body frame. Furthermore, the sub frame that supports the battery pack from the vehicle lower side includes the cross member that is installed so as to span between the side frames at the vehicle lower side of the battery pack, and the energy absorption member is disposed at the vehicle width direction outer side of the battery pack and at the vehicle lower side of each side frame.

In this regard, in a bottom view, the vehicle width direction outer side end portion of the cross member is bent toward the vehicle front-rear direction outer side, starting from the portion at which the vehicle width direction outer side end portion reaches the energy absorption member, and is attached to the side frame, and the vehicle front-rear direction outer side end portion of the energy absorption member is disposed along the face, of the vehicle width direction outer side end portion of the cross member, that faces toward the vehicle front-rear direction inner side. Further, the reinforcing member including the flat face that faces the energy absorption member in the vehicle width direction is provided at the portion at which the cross member is bent.

Accordingly, during a side collision or the like of the vehicle, even if a load is input to the energy absorption member from the vehicle width direction outer side, a tensile stress that is relatively directed toward the vehicle width direction outer side by the vehicle width direction outer side end portion of the cross member is unlikely to be exerted on the vehicle front-rear direction outer side end portion of the energy absorption member, and the energy absorption member is unlikely to be broken. Consequently, a load that has been input from the vehicle width direction outer side is effectively absorbed by the energy absorption member, and is effectively received by the reinforcing member. That is to say, a reduction in impact absorption performance with respect to a load that is input from the vehicle width direction outer side is suppressed.

Further, a vehicle lower portion structure of a third aspect according to the present disclosure is the vehicle lower portion structure of the first aspect or the second aspect, wherein the reinforcing member is formed in a triangular shape, in a bottom view, including an inclined wall positioned between a face, of the cross member, that faces toward the vehicle front-rear direction inner side, and a face, of the energy absorption member, that faces toward a vehicle width direction inner side.

According to the vehicle lower portion structure of the third aspect, the reinforcing member is formed in a triangular shape, in a bottom view, including the inclined wall positioned between the face, of the cross member, that faces toward the vehicle front-rear direction inner side, and the face, of the energy absorption member, that faces toward the vehicle width direction inner side. Accordingly, a rigidity of the reinforcing member is improved, and a load that has been input from the vehicle width direction outer side is effectively received by the reinforcing member and the cross member.

As described above, according to the present disclosure, a reduction in impact absorption performance with respect to a load that is input from a vehicle width direction outer side can be suppressed.

### BRIEF DESCRIPTION OF THE DRAWINGS

An exemplary embodiment of the present disclosure will be described in detail based on the following figures, wherein:

FIG. 1 is a schematic bottom view illustrating a vehicle body lower portion structure according to the present exemplary embodiment;

FIG. 2 is a schematic perspective view illustrating the vehicle body lower portion structure according to the present exemplary embodiment;

FIG. 3 is a schematic exploded perspective view illustrating the vehicle body lower portion structure according to the present exemplary embodiment;

FIG. 4 is a schematic rear view viewed along X-X line arrows in FIG. 1;

FIG. 5 is a schematic bottom view illustrating a portion of the vehicle body lower portion structure according to the present exemplary embodiment in an enlarged manner; and

FIG. 6 is a schematic bottom view illustrating a state when a load has been input to the vehicle body lower portion structure according to the present exemplary embodiment.

### DETAILED DESCRIPTION

An exemplary embodiment of the present disclosure will be explained in detail below based on the drawings. It should be noted that, for convenience of explanation, arrow UP, arrow FR, and arrow RH, which are illustrated in the respective drawings as appropriate, respectively indicate a vehicle upward direction, a vehicle frontward direction, and a vehicle rightward direction. Further, unless specifically stated otherwise, in cases in which up-down, front-rear, and left-right directions are referred to in the following explanation, these respectively indicate up and down, front and rear, and left and right of the vehicle. Furthermore, the left-right direction has the same meaning as the vehicle width direction.

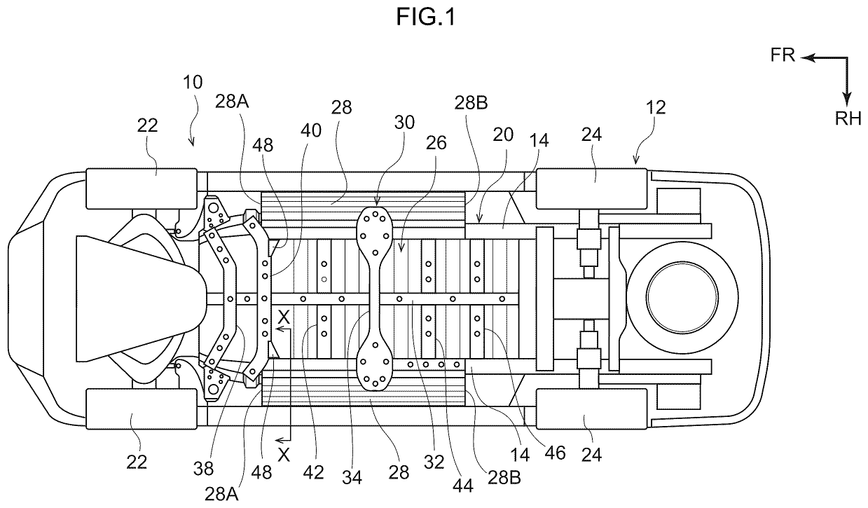

As illustrated in FIG. 1, a frame vehicle 12 serving as a vehicle provided with a vehicle lower portion structure 10 according to the present exemplary embodiment is mainly a battery electric vehicle (BEV) or a fuel cell electric vehicle (FCEV). The frame vehicle 12 includes a left and right pair of side frames 14 that are disposed at vehicle width direction outer sides, and that extend in the front-rear direction. Each side frame 14 is formed with a rectangular closed cross-sectional shape in a cross-sectional view viewed from the front-rear direction. It should be noted that a front wheel 22 and a rear wheel 24 are respectively disposed at a vehicle width direction outer side at a front portion side and a rear portion side of each side frame 14.

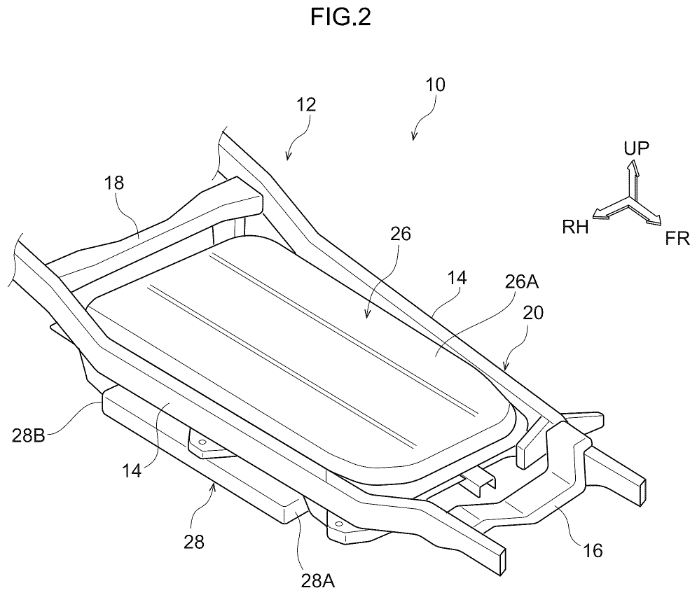

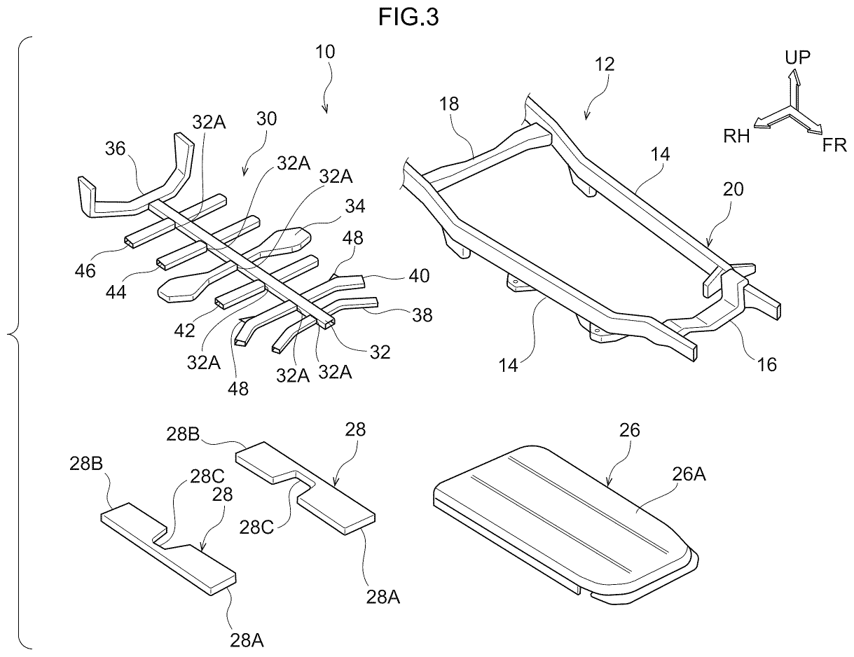

Further, as illustrated in FIG. 2 and FIG. 3, since a suspension unit (refer to FIG. 1) and the like are disposed at a lower side at the front portion side and the rear portion side of each side frame 14, the front portion side and the rear portion side of each side frame 14 are positioned further toward an upper side than a central portion side of each side frame 14 in a side view viewed from the vehicle width direction. That is to say, the front portion side and the rear portion side of each side frame 14 respectively have inclined portions that are inclined toward a front upper side and a rear upper side from the central portion side, and respectively extend toward the front side and the rear side from the inclined portions.

Furthermore, a front portion coupling frame 16 (front portion frame) that extends along the vehicle width direction is installed so as to span between front portions (front side portions) of the side frames 14, and a rear portion coupling frame 18 (rear portion frame) that extends along the vehicle width direction is installed so as to span between rear portions (rear side portions) of the side frames 14. That is to say, front end portions of the side frames 14 are coupled in the vehicle width direction by the front portion coupling frame 16, and rear end portions of the side frames 14 are coupled in the vehicle width direction by the rear portion coupling frame 18. Consequently, a vehicle body frame 20 having a substantially rectangular frame shape in a plan view is configured.

Further, as illustrated in FIG. 2 and FIG. 3, the battery pack 26 is disposed at an inner side the vehicle body frame 20 (between the side frames 14). The battery pack 26 includes a case 26A having a substantially rectangular box shape that houses plural battery cells (not illustrated in the drawings), and is configured to be supported from a lower side by a sub frame 30 that is disposed at the inner side of the vehicle body frame 20. That is to say, the sub frame 30 is disposed at a lower side of the battery pack 26.

The sub frame 30 is formed of, for example, a high-tensile steel material or the like, and includes a first frame 32 having a rectangular closed cross-sectional shape extending in the front-rear direction at a vehicle width direction central portion of the vehicle body frame 20, and a second frame 34 having a rectangular closed cross-sectional shape extending in the vehicle width direction at a substantially front-rear direction central portion of the vehicle body frame 20.

That is to say, the sub frame 30 is configured substantially in a “+” shape in a plan view by the first frame 32 and the second frame 34, is assembled due to a vehicle width direction central portion of the second frame 34 being fit into a rectangular cutout portion 32A that is formed at a substantially front-rear direction central portion of the first frame 32, and is integrally joined by welding or the like.

Further, vehicle width direction outer side end portions of the second frame 34 are each formed wider so as to have a substantially elliptical shape in a plan view, and are configured to be respectively fastened and attached to lower faces of the side frames 14. That is to say, the second frame 34 is installed so as to span between the pair of side frames 14. It should be noted that the first frame 32 is configured so as to have a higher rigidity than the second frame 34. Specifically, the first frame 32 is formed so as to have, for example, a thicker plate thickness than the second frame 34.

Further, the sub frame 30 includes a third frame 36 that extends along the vehicle width direction at a rear portion of the vehicle body frame 20, and a rear end portion of the first frame 32 is integrally joined to a vehicle width direction central portion of the third frame 36 by welding or the like. Furthermore, the third frame 36 is formed substantially in a U-shape that is bent such that both left and right direction end portions extend toward the upper side in a rear view viewed from the front-rear direction.

Further, in order to suppress twisting of the vehicle body frame 20 (in order to improve durability and strength performance), the sub frame 30 includes plural cross members that are formed with a rectangular closed cross-sectional shape, that extend in the vehicle width direction, and that are installed so as to span between the pair of side frames 14. That is to say, the sub frame 30 includes three cross members 38, 40, 42 at regular intervals in the front-rear direction at a front side of the second frame 34, and includes two cross members 44, 46 at regular intervals in the front-rear direction between the second frame 34 and the third frame 36.

Three rectangular cutout portions 32A are formed at regular intervals in the front-rear direction at the first frame 32 further toward the front side than the second frame 34, and vehicle width direction central portions of the cross members 38, 40, 42 are assembled by being respectively fit into the cutout portions 32A, and are integrally joined by welding or the like. Vehicle width direction outer side end portions of each of the cross members 38, 40, 42 are respectively attached to the side frames 14.

Similarly, two rectangular cutout portions 32A are formed at regular intervals in the front-rear direction at the first frame 32 further toward the rear side than the second frame 34, and vehicle width direction central portions of the cross members 44, 46 are assembled by being respectively fit into the cutout portions 32A, and are integrally joined by welding or the like. Vehicle width direction outer side end portions of each of the cross members 44, 46 are respectively attached to the side frames 14.

Further, as illustrated in FIG. 1 to FIG. 4, energy absorption members 28 that are each formed in a lattice shape in a cross-sectional view viewed from the front-rear direction are respectively disposed at vehicle width direction outer sides of the battery pack 26 and at lower sides of the side frames 14. A cutout portion 28C substantially having a U-shape in a plan view is formed at a vehicle width direction inner side of a substantially front-rear direction central portion of each energy absorption member 28, and is configured to be able to accommodate a vehicle width direction outer side end portion of the second frame 34.

Furthermore, as illustrated in FIG. 1, rear end portions (front-rear direction outer side end portions) 28B of the energy absorption members 28 extend to positions that are in proximity to the cross member 46, which is at the rearmost side, and front end portions (front-rear direction outer side end portions) 28A of the energy absorption members 28 extend to positions that are not beyond the cross member 40, which is the second cross member from the front side. Here, a positional relationship between vehicle width direction outer side end portions of the cross member 40 and the front end portions 28A of the energy absorption members 28 will be explained.

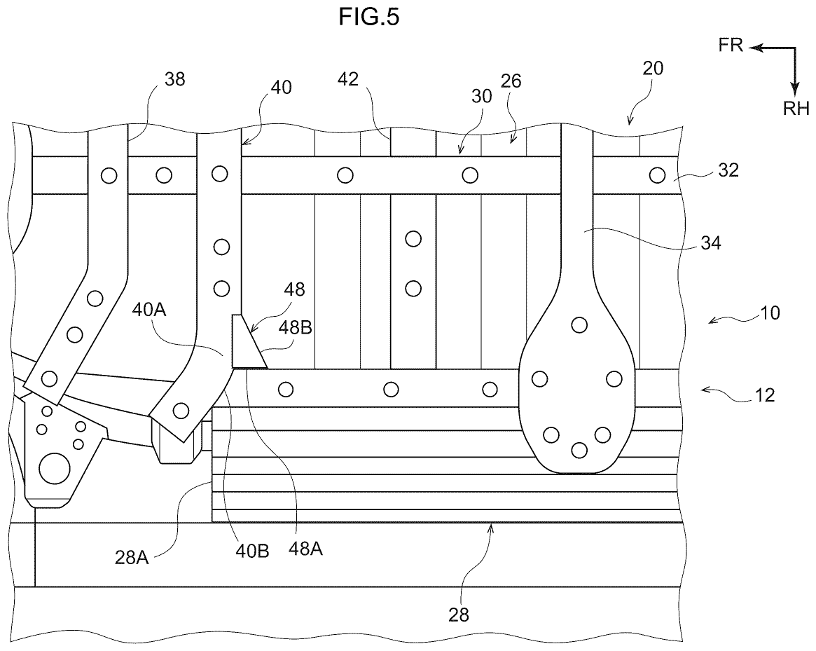

As illustrated in FIG. 1 and FIG. 5, in a bottom view, the vehicle width direction outer side end portion of the cross member 40 is bent toward the front side (front-rear direction outer side), starting from a portion at which it reaches the energy absorption member 28, and is attached to the lower face of the side frame 14. Further, in a bottom view, a vehicle width direction inner side portion of the front end portion 28A of the energy absorption member 28 is disposed along a rear face (a face that faces toward a front-rear direction inner side) 40B of the vehicle width direction outer side end portion of the cross member 40. In other words, in a bottom view, the vehicle width direction inner side portion of the front end portion 28A of the energy absorption member 28 is cut into a shape that is along the rear face 40B of the vehicle width direction outer side end portion of the cross member 40.

Further, a gusset 48, serving as a reinforcing member including a flat face 48A that faces the energy absorption member 28 in the vehicle width direction, is provided at the portion at which the cross member 40 is bent (hereafter referred to as a “bent portion”) 40A. The gusset 48 is formed in a substantially triangular shape in a bottom view, and a front portion thereof is integrally joined to a lower face and a rear face of the bent portion 40A of the cross member 40 by welding or the like.

Consequently, a configuration is provided in which a vehicle width direction outer side end portion of the gusset 48 is configured as the flat face 48A and faces the energy absorption member 28 in proximity thereto or in contact therewith. Further, a rear portion of the gusset 48 is configured as an inclined wall 48B that is positioned between a rear face (a face that faces toward the vehicle front-rear direction inner side) of the cross member 40 further toward the vehicle width direction inner side than the bent portion 40A, and an inner face (a face that faces toward the vehicle width direction inner side) of the energy absorption member 28, in a bottom view.

Next, operation of the vehicle lower portion structure 10 according to the present exemplary embodiment configured as described above will be explained.

As described above, the front portions of the left and right pair of side frames 14 that extend in the front-rear direction are coupled in the vehicle width direction by the front portion coupling frame 16, and the rear portions of the side frames 14 are coupled in the vehicle width direction by the rear portion coupling frame 18, thereby configuring the vehicle body frame 20. Further, the battery pack 26 is disposed at the inner side of the vehicle body frame 20 (between the side frames 14). That is to say, the battery pack 26 is supported from the lower side by the sub frame 30.

In this regard, the first frame 32 of the sub frame 30, which is provided with high rigidity, extends in the front-rear direction at a vehicle width direction central portion of the vehicle body frame 20 at a lower side of the battery pack 26, and the second frame 34 of the sub frame 30 is installed so as to span between the side frames 14 at a substantially front-rear direction central portion of the vehicle body frame 20. Accordingly, the battery pack 26, which is a heavy object, can be stably supported.

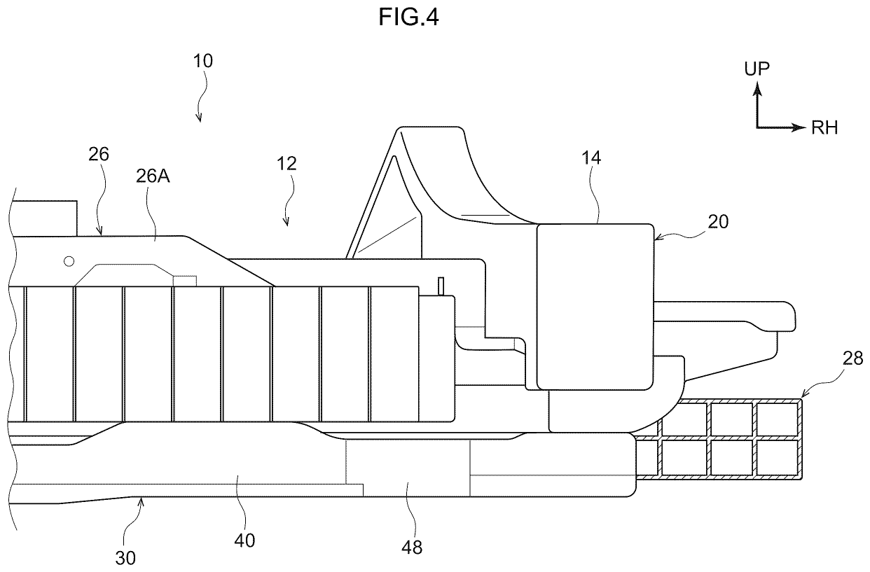

Further, as illustrated in FIG. 4, since the sub frame 30 is positioned at a lower side of the vehicle body frame 20 (the side frames 14) in a side view, the battery pack 26 is surrounded by the vehicle body frame 20. More specifically, at least a portion of the battery pack 26 in the height direction overlaps with the vehicle body frame 20 in a side view, and at least a portion of the battery pack 26 in the height direction is surrounded by the vehicle body frame 20.

Accordingly, mounting stability performance of the battery pack 26 can be improved, and protection performance with respect to the battery pack 26 during a collision of the frame vehicle 12 can be improved. That is to say, even if a collision load is input to the frame vehicle 12 from the front-rear direction or the vehicle width direction, the battery pack 26 can be effectively protected from the collision load.

Further, the energy absorption members 28 are disposed at vehicle width direction outer sides of the battery pack 26 and at lower sides the side frames 14, and the sub frame 30 includes the cross member 40 that extends in the vehicle width direction. Furthermore, in a bottom view, the vehicle width direction outer side end portions of the cross member 40 are bent toward the front side, starting from portions at which they reach the energy absorption members 28, and are attached to the side frames 14, and the front end portions 28A of the energy absorption members 28 are disposed along the rear faces 40B of the vehicle width direction outer side end portions of the cross member 40. Moreover, the gussets 48 including the flat faces 48A that face the energy absorption members 28 in the vehicle width direction are provided at the bent portions 40A of the cross member 40.

Accordingly, during a side collision or the like of the frame vehicle 12, even if a load is input to the energy absorption member 28 from the vehicle width direction outer side, a tensile stress that is relatively directed toward the vehicle width direction outer side by the vehicle width direction outer side end portion of the cross member 40 is unlikely to be exerted on the front end portion 28A of the energy absorption member 28, and the energy absorption member 28 is unlikely to be broken. Further, the vehicle width direction inner side portion of the front end portion 28A of the energy absorption member 28 is effectively supported from the vehicle width direction inner side by the flat face 48A of the gusset 48.

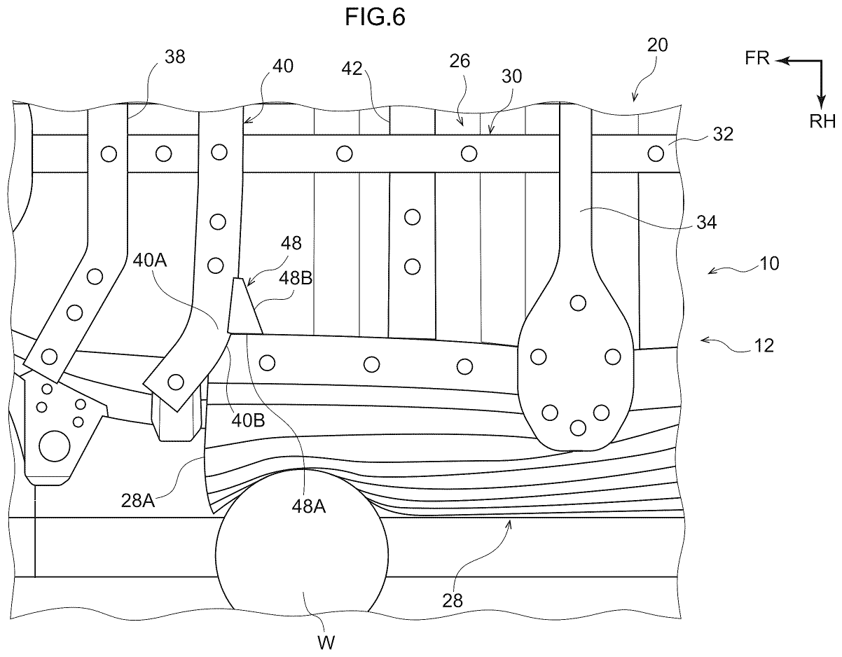

Consequently, as illustrated in FIG. 6, a load that has been input from the vehicle width direction outer side by an obstacle W or the like is effectively absorbed by the energy absorption member 28, and is effectively received by the flat face 48A (the energy absorption member 28 that is supported by the flat face 48A) of the gusset 48. Thus, a reduction in impact absorption performance with respect to a load that is input from the vehicle width direction outer side during a side collision or the like of the frame vehicle 12 can be suppressed.

Moreover, the gusset 48 is formed in a substantially triangular shape in a bottom view including the inclined wall 48B that is positioned between a rear face of the cross member 40 and an inner face of the energy absorption member 28. Accordingly, compared to the case of a gusset that is not formed in such a substantially triangular shape in a bottom view (not illustrated in the drawings), a rigidity of the gusset 48 can be improved, and a load that has been input from the vehicle width direction outer side can be effectively received by the gusset 48 and the cross member 40.

More specifically, a load that has been input to the flat face 48A of the gusset 48 from the vehicle width direction outer side can be efficiently transmitted to the cross member 40 via the front portion and the rear portion (the inclined wall 48B) of the gusset 48, and can therefore be effectively received by the cross member 40, and moreover by the side frame 14 (the vehicle body frame 20).

Although the vehicle lower portion structure 10 according to the present exemplary embodiment has been explained above based on the drawings, the vehicle lower portion structure 10 according to the present exemplary embodiment is not limited to that which is illustrated in the drawings, and design modifications can be appropriately carried out within a range that does not depart from the spirit of the present disclosure. For example, the vehicle according to the present exemplary embodiment is not limited to the frame vehicle 12. Furthermore, the respective cross members 38, 40, 42, 44, 46 are not limited to being formed with a rectangular closed cross-sectional shape, and may be formed with a substantially U-shaped cross-sectional shape.

Further, although the cross member 40 that is positioned at the front end portion 28A of the energy absorption member 28 has been explained in the aforementioned exemplary embodiment, a similar configuration may be provided for the cross member 46 that is positioned at (in proximity to) the rear end portion 28B of the energy absorption member 28. Furthermore, it is sufficient for the gusset 48 to have a shape that is capable of effectively receiving a load that has been input from the vehicle width direction outer side, and it is not limited to being formed in a substantially triangular shape in a bottom view.

What is claimed is:

1. A vehicle lower portion structure comprising:
a left and right pair of side frames that extend in a vehicle front-rear direction;
a battery pack that is disposed between the side frames;
a cross member that is installed so as to span between the side frames at a vehicle lower side of the battery pack; and
an energy absorption member that is disposed at a vehicle width direction outer side of the battery pack and at a vehicle lower side of each side frame,
wherein:
in a bottom view, a vehicle width direction outer side end portion of the cross member is bent toward a vehicle front-rear direction outer side, starting from a portion at which the vehicle width direction outer side end portion reaches the energy absorption member, and is attached to one of the side frames, and a vehicle front-rear direction outer side end portion of the energy absorption member is disposed along a face, of the vehicle width direction outer side end portion of the cross member, that faces toward a vehicle front-rear direction inner side, and
a reinforcing member including a flat face that faces the energy absorption member in a vehicle width direction is provided at a portion at which the cross member is bent.

2. A vehicle lower portion structure comprising:
a vehicle body frame including a left and right pair of side frames that extend in a vehicle front-rear direction, a front portion frame that couples vehicle front side portions of the side frames in a vehicle width direction, and a rear portion frame that couples vehicle rear side portions of the side frames in the vehicle width direction;
a battery pack that is disposed at an inner side of the vehicle body frame;
a sub frame that includes a cross member installed so as to span between the side frames at a vehicle lower side of the battery pack, and that supports the battery pack from the vehicle lower side; and
an energy absorption member that is disposed at a vehicle width direction outer side of the battery pack and at a vehicle lower side of each side frame,
wherein:
in a bottom view, a vehicle width direction outer side end portion of the cross member is bent toward a vehicle front-rear direction outer side, starting from a portion at which the vehicle width direction outer side end portion reaches the energy absorption member, and is attached to one of the side frames, and a vehicle front-rear direction outer side end portion of the energy absorption member is disposed along a face, of the vehicle width direction outer side end portion of the cross member, that faces toward a vehicle front-rear direction inner side, and
a reinforcing member including a flat face that faces the energy absorption member in the vehicle width direction is provided at a portion at which the cross member is bent.

3. The vehicle lower portion structure according to claim 1, wherein the reinforcing member is formed in a triangular shape, in a bottom view, including an inclined wall positioned between a face, of the cross member, that faces toward the vehicle front-rear direction inner side, and a face, of the energy absorption member, that faces toward a vehicle width direction inner side.

4. The vehicle lower portion structure according to claim 2, wherein the reinforcing member is formed in a triangular shape, in a bottom view, including an inclined wall positioned between a face, of the cross member, that faces toward the vehicle front-rear direction inner side, and a face, of the energy absorption member, that faces toward a vehicle width direction inner side.
